(19) United States
(12) Patent Application Publication
(10) Pub. No.: US 2013/0162552 A1
(43) Pub. Date: Jun. 27, 2013

(54) TOUCH DEVICES AND FABRICATION METHODS THEREOF

(71) Applicants: Cheng-Chung HUANG, Taoyuan (TW); Ching-Chao Wang, Nantou (TW); Jeng-Maw Chiou, Hsinchu (TW)

(72) Inventors: Cheng-Chung HUANG, Taoyuan (TW); Ching-Chao Wang, Nantou (TW); Jeng-Maw Chiou, Hsinchu (TW)

(21) Appl. No.: 13/545,656

(22) Filed: Jul. 10, 2012

(30) Foreign Application Priority Data
Dec. 26, 2011 (CN) 201110461271.3

(51) Int. Cl. B05D 3/06; B05D 5/12; G06F 3/041

(52) U.S. Cl. 345/173; 427/555

(57) ABSTRACT

A touch device and a fabrication method thereof are provided. The touch device includes a cover lens, a light shielding pattern disposed on the cover lens, a UV cut layer disposed on the light shielding pattern and the cover lens, and a plurality of transparent conductive patterns disposed on the UV cut layer, wherein the transparent conductive patterns are formed by using a laser beam to etch a transparent conductive layer.

### CROSS REFERENCE TO RELATED APPLICATIONS

This Application claims priority of the People's Republic of China Patent Application No. 201110461271.3, filed on Dec. 26, 2011, the entirety of which is incorporated by reference herein.

### BACKGROUND OF THE INVENTION

1. Field of the Invention

The present invention relates to a touch device, and in particular relates to a touch device fabricated by a laser etching method.

2. Description of the Related Art

Currently, in touch devices, transparent conductive patterns are usually formed of a transparent conductive material. In a conventional method of fabricating a touch device, firstly, a transparent conductive film is completely coated on a carrier substrate of the touch device. Then, the transparent conductive film is patterned by a photolithography and etching technology to form transparent conductive patterns.

The photolithography and etching technology requires firstly coating a photo resist layer on the transparent conductive film and then using a photo mask pattern to perform an exposure process on the photo resist layer. Next, the photo resist layer is patterned by a development process. Then, the patterned photo resist layer is used as a mask to perform a wet etching process on the transparent conductive film to form the transparent conductive patterns. Thus, the conventional method of fabricating a touch device is very complex. It requires many steps and many pieces of processing equipment to complete the fabrication of the transparent conductive patterns. Accordingly, the cost of the conventional fabrication of the touch devices is high, and the conventional fabrication of touch devices is time-consuming.

### BRIEF SUMMARY OF THE INVENTION

Therefore, the embodiments of the invention provide methods of fabricating touch devices, which use a laser etching method to form a plurality of transparent conductive patterns. Thus, this saves time and money in fabricating the touch devices. The above-mentioned problems with the conventional fabrication methods of touch devices are overcome.

According to an illustrative embodiment, a method of fabricating a touch device is provided. The method comprises: providing a cover lens; forming a light shielding pattern on the cover lens; coating a UV cut layer on the light shielding pattern and the cover lens; forming a transparent conductive layer on the UV cut layer; and using a laser beam to directly etch the transparent conductive layer to form a plurality of transparent conductive patterns.

According to an illustrative embodiment, a touch device is provided. The touch device comprises a cover lens. A light shielding pattern is disposed on the cover lens. A UV cut layer is disposed on the light shielding pattern and the cover lens. Furthermore, a plurality of transparent conductive patterns is disposed on the UV cut layer.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 shows an illustrative top view of a touch device according to an embodiment of the invention;

FIG. 2A shows an illustrative cross section of a touch device along the cross section line 2-2′ of FIG. 1 according to an embodiment of the invention;

FIG. 2B shows an illustrative cross section of a touch device along the cross section line 2-2′ of FIG. 1 according to another embodiment of the invention; and

FIGS. 3A and 3B show illustrative enlarged top views of a plurality of transparent conductive patterns formed by a laser etching method according to various embodiments of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

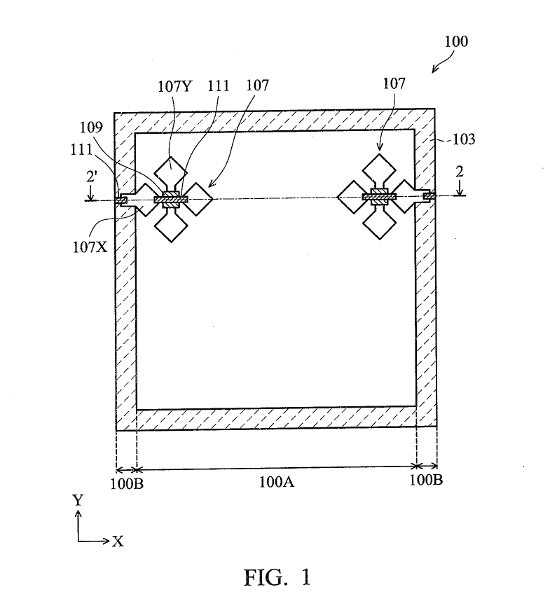

Referring to FIG. 1, a top view of a touch device 100 according to an embodiment of the invention is shown. A light shielding pattern 103 is disposed in a peripheral area 100B of the touch device 100. A plurality of transparent conductive patterns 107 is disposed in a touch sensing area 100A of the touch device 100. The transparent conductive patterns 107 include a plurality of first patterns 107X arranged along a first direction, for example an X-axis direction. The first patterns 107X are separated from each other to form a plurality of intermittent touch sensing lines along the X-axis direction. The transparent conductive patterns 107 further include a plurality of second patterns 107Y arranged along a second direction perpendicular to the first direction, for example a Y-axis direction. The second patterns 107Y are connected with each other to form a plurality of continuous touch sensing lines along the Y-axis direction.

A transparent insulating pattern 109 is disposed at the locations of the touch sensing lines formed of the first patterns 107X crossing the touch sensing lines formed of the second patterns 107Y, i.e. at the locations between any two adjacent first patterns 107X. Then, a metal pattern 111 is disposed on the transparent insulating pattern 109 for electrically connecting any two adjacent first patterns 107X together. The transparent insulating pattern 109 can electrically isolate the touch sensing lines formed of the second patterns 107Y from the metal pattern 111. This can prevent a short from occurring between the touch sensing lines of the Y-axis direction and the touch sensing lines of the X-axis direction.

Moreover, a portion of the first pattern 107X and a portion of the metal pattern 111 are extended to the peripheral area 100B of the touch device 100 and disposed on the light shielding pattern 103.

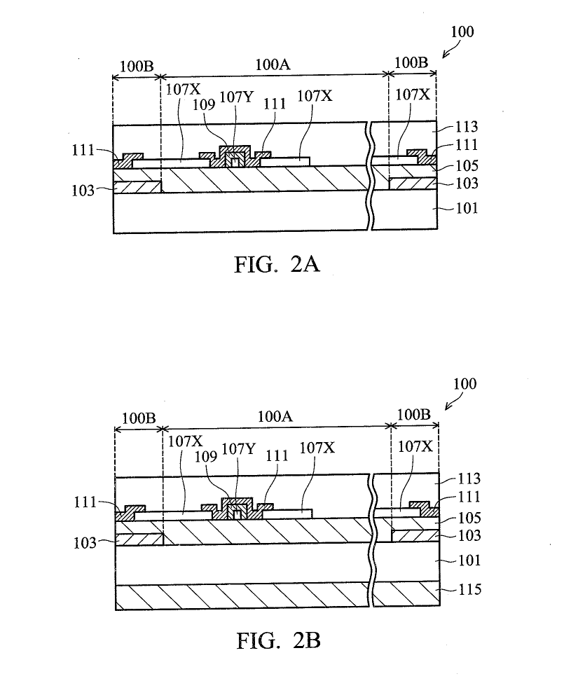

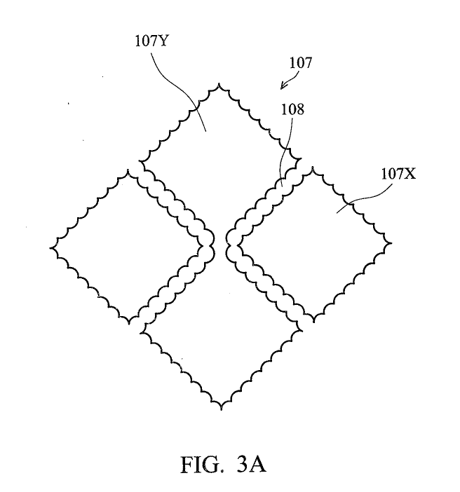

Referring to FIG. 2A, a cross section of the touch device 100 along the cross section line 2-2′ of FIG. 1 according to an embodiment of the invention is shown. According to an embodiment of a fabrication method of the touch device 100, first, a cover lens 101 of the touch device 100, for example a tempered glass substrate, is provided. Next, the light shielding pattern 103 is formed in the peripheral area 100B on the cover lens 101. The light shielding pattern 103 is formed of an opaque material, for example a black photo resist. In one embodiment, a black photo resist layer is coated on the cover lens 101 and then patterned by a photolithography process to the light shielding pattern 103. In another embodiment, the light shielding pattern 103 may be directly formed by a printing process.

An UV cut layer 105 is completely formed on the light shielding pattern 103 and the cover lens 101. The UV cut layer 105 can cut off a UV light of a wavelength of less than 400 nm or less than 300 nm. The material of the UV cut layer 105 is a transparent insulating material such as a mixture of SiO₂ and SiN. Moreover, the material of the UV cut layer 105 can be selected from other suitable materials which can cut off a UV light with a wavelength of less than 400 nm or less than 300 nm. In embodiments of the invention, the UV cut layer 105 may be a single-layered or a multi-layered optical thin film structure.

A transparent conductive layer, for example an indium tin oxide (ITO) layer or a fluorine-doped tin oxide (FTO) layer or other transparent conductive oxide, is completely coated on the UV cut layer 105. Then, a laser beam irradiates on the transparent conductive layer from a side of the cover lens 101 with the transparent conductive layer thereon for directly etching the transparent conductive layer to form the plurality of transparent conductive patterns 107. In an embodiment, the transparent conductive patterns 107 include the plurality of first patterns 107X and the plurality of second patterns 107Y as shown in FIG. 1.

In an embodiment, the laser beam has a wavelength of 355 nm and the UV cut layer 105 cuts off a UV light of a wavelength of less than 400 nm. In another embodiment, the laser beam has a wavelength of 266 nm and the UV cut layer 105 cuts off a UV light of a wavelength of less than 300 nm. Therefore, when the laser beam directly etches the transparent conductive layer to form the first patterns 107X and the second patterns 107Y, the UV cut layer 105 can protect the underlying light shielding pattern 103 from damage by the laser beam.

A transparent insulating layer is coated on the transparent conductive patterns 107 and then patterned by a photolithography process to form the transparent insulating pattern 109 between any two adjacent first patterns 107X. The transparent insulating pattern 109 covers a connecting portion of the second patterns 107Y.

A metal layer is formed on the transparent conductive patterns 107 and the transparent insulating pattern 109 and then the metal layer is patterned by a photolithography and development process to form the metal pattern 111 on the transparent insulating pattern 109. A portion of the metal pattern 111 is formed between the first patterns 107X in the touch sensing area 100A and used as a bridge structure for electrically connecting any two adjacent first patterns 107X. Meanwhile, another portion of the metal pattern 111 is formed above the light shielding pattern 103 in the peripheral area 100B and extends onto the first pattern 107X.

A protective layer 113 is formed to completely cover the transparent conductive patterns 107 and the metal pattern 111 for protecting all elements of the touch device 100. The material of the protective layer 113 may be an organic or an inorganic insulating material. The inorganic insulating material is, for example, silicon oxide or silicon nitride. The organic insulating material is, for example, an acrylic-based photo resist. In an embodiment of the invention, the plurality of transparent conductive patterns 107 is formed on the cover lens 101. Accordingly, the touch device 100 can be referred to as a touch sensor on cover glass.

The adhesion between the material of the metal pattern 111, the material of the first patterns 107X and the second patterns 107Y and the material of the light shielding pattern 103 is poor. However, the adhesion strength between the metal pattern 111, the first patterns 107X, the second patterns 107Y and the light shielding pattern 103 can be improved through the UV cut layer 105 of the embodiments of the invention. Therefore, the reliability of the touch device 100 according to the embodiments of the invention is also enhanced.

Furthermore, according to the embodiments of the invention, the UV cut layer 105 has a refractive index almost equal to a refractive index of the cover lens 101. Therefore, the UV cut layer 105 can increase a light transmission in the touch sensing area 100A and the quality of display images of the touch device 100 in the touch sensing area 100A is also enhanced. Meanwhile, the refractive index of the UV cut layer 105 is also almost equal to a refractive index of the first patterns 107X and the second patterns 107Y. Therefore, the UV cut layer 105 can also make the contours of the first patterns 107X and the second patterns 107Y hardly visible to the naked eyes. The quality of display images of the touch device 100 in the touch sensing area 100A is further enhanced.

In an embodiment, the refractive index of the UV cut layer 105 is between the refractive index of the cover lens 101 and the refractive index of the first patterns 107X and the second patterns 107Y.

In addition, according to the embodiments of the invention, the UV cut layer 105 can improve the flatness between the cover lens 101 and the light shielding pattern 103 and reduce the influence of the step of the light shielding pattern 103. This is contributive to the fabrication of the transparent conductive patterns 107 because the first patterns 107X and the second patterns 107Y can be formed on a flat surface of the UV cut layer 105. Thus, a break issue of the transparent conductive patterns 107 occurred by directly forming on the step of the light shielding pattern 103 is avoided through the UV cut layer 105.

Referring to FIG. 2B, a cross section of the touch device 100 along the cross section line 2-2′ of FIG. 1 according to another embodiment of the invention is shown. The difference between the touch device 100 of FIG. 2B and the touch device 100 of FIG. 2A is that an additional UV cut layer 115 is formed on an outside surface of the cover lens 101, such that both sides of the cover lens 101 have UV cut layers formed thereon. The UV cut layer 115 can cut off a UV light of a wavelength of less than 400 nm or less than 300 nm. The material of the UV cut layer 115 is a transparent insulating material such as a mixture of SiO₂ and SiN. Moreover, the material of the UV cut layer 115 can be selected from other suitable materials which can cut off a UV light of a wavelength of less than 400 nm or less than 300 nm. The material of the UV cut layer 115 may be the same as that of the UV cut layer 105. In addition, the UV cut layer 115 may be a single-layered or a multi-layered optical thin film structure.

According to the touch device 100 of an embodiment of the invention, as shown in FIG. 2A, only one side of the cover lens 101 has the UV cut layer 105 formed thereon and the UV cut layer 105 is a single-layered film structure. Compared to the conventional touch devices without the UV cut layer 105, a light transmission in the touch sensing area 100A of the touch device 100 of the embodiment of the invention can be increased from about 90% to about 94%. Moreover, if the UV cut layer 105 is a multi-layered film structure, compared to the conventional touch devices without the UV cut layer 105, a light transmission in the touch sensing area 100A of the touch device 100 of the embodiment of the invention can be increased from about 90% to about 95%.

According to the touch device 100 of another embodiment of the invention, as shown in FIG. 2B, both two sides of the cover lens 101 have the UV cut layer 105 and the UV cut layer 115 formed thereon respectively and the UV cut layer 105 and the UV cut layer 115 both are a single-layered film structure. Compared to the conventional touch devices without the UV cut layers 105 and 115, a light transmission in the touch sensing area 100A of the touch device 100 of the embodiment of the invention can be increased from about 90% to about 96%. Moreover, if the UV cut layers 105 and 115 both are a multi-layered film structure, compared to the conventional touch devices without the UV cut layers 105 and 115, a light transmission in the touch sensing area 100A of the touch device 100 of the embodiment of the invention can be increased from about 90% to about 99%.

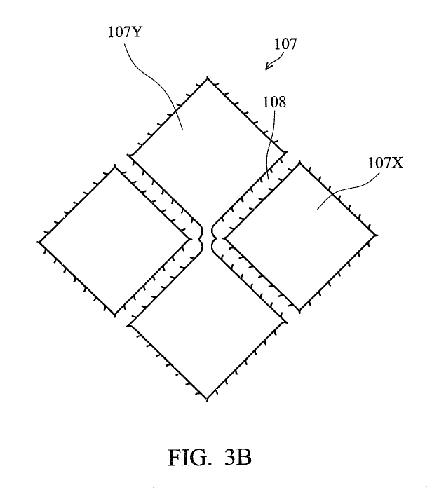

Referring to FIGS. 3A and 3B, enlarged top views of the plurality of transparent conductive patterns 107 formed by using a laser beam to directly etch a transparent conductive layer according to the embodiments of the invention are shown. A space pattern 108 between the transparent conductive patterns 107 is formed by using a laser beam to directly etch a transparent conductive layer. The space pattern 108 consists of a plurality of partially overlapping points. The shape of the points may be a circle, a square, a rectangle, an ellipse, a rectangle with four round corners or other suitable shapes which help for the etching efficiency of the laser beam. As shown in FIG. 3A, wherein one point formed by using a laser beam to etch the transparent conductive layer is a circle and these circular points partially overlap to form the space pattern 108. Further, the space pattern 108 as shown in FIG. 3B is formed of a plurality of partially overlapping points and these points have a shape of a rectangle with four round corners.

Compared with the conventional methods of fabricating transparent conductive patterns in conventional touch devices, the embodiments of the invention using a laser beam etching process to form transparent conductive patterns can reduce the equipment cost of fabricating the touch devices and decrease the space required for the fabrication equipment. Moreover, the laser beam etching process used in the embodiments of the invention does not need a photo mask. The design change for the transparent conductive patterns is easily achieved by using the laser beam etching process. Furthermore, according to the embodiments of the invention, the cost of fabricating the touch devices is reduced and the yield rate of fabricating the touch devices is also enhanced.

As mentioned above, the fabrication methods of the touch devices of the embodiments of the invention use the laser beam etching process to form the transparent conductive patterns, thus the cost of fabricating the touch devices is reduced. Moreover, the touch devices of the embodiments of the invention have a UV cut layer disposed between the light shielding pattern and the transparent conductive patterns, such that a light transmission in the touch sensing area is enhanced. Meanwhile, the visible issue of the outlines of the transparent conductive patterns is overcome and the light shielding pattern can be protected by the UV cut layer. Furthermore, the flatness between the cover lens and the light shielding pattern is also enhanced by the UV cut layer. The adhesion strength between the transparent conductive patterns and the light shielding pattern is also improved by the UV cut layer and thus the reliability of the touch devices of the embodiments is enhanced.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method of fabricating a touch device, comprising:
providing a cover lens;
forming a light shielding pattern on the cover lens;
coating a UV cut layer on the light shielding pattern and the cover lens;
forming a transparent conductive layer on the UV cut layer; and
using a laser beam to etch the transparent conductive layer to form a plurality of transparent conductive patterns.

2. The method of claim 1, wherein the UV cut layer cuts off a UV light having a wavelength of less than 400 nm.

3. The method of claim 2, wherein the laser beam has a wavelength of 355 nm.

4. The method of claim 1, wherein the UV cut layer cuts off a UV light having a wavelength of less than 300 nm.

5. The method of claim 4, wherein the laser beam has a wavelength of 266 nm.

6. The method of claim 1, further comprising forming another UV cut layer on another side of the cover lens opposite the side of the cover lens with the UV cut layer thereon.

7. The method of claim 1, wherein the step of using the laser beam to etch the transparent conductive layer further forms a space pattern between the transparent conductive patterns.

8. The method of claim 7, wherein the space pattern consists of a plurality of partially overlapping points.

9. The method of claim 8, wherein the shape of the partially overlapping points comprises a circle, a square, a rectangle, an ellipse or a rectangle with four round corners.

10. A touch device, comprising:
a cover lens;
a light shielding pattern disposed on the cover lens;
a UV cut layer disposed on the light shielding pattern and the cover lens; and
a plurality of transparent conductive patterns disposed on the UV cut layer.

11. The touch device of claim 10, wherein the transparent conductive patterns comprise:
a plurality of first patterns, arranged along a first direction, wherein the first patterns are separated from each other; and
a plurality of second patterns, arranged along a second direction perpendicular to the first direction, wherein the second patterns are connected with each other.

12. The touch device of claim 11, further comprising:
a transparent insulating pattern, disposed between any two adjacent first patterns; and
a metal pattern, disposed on the transparent insulating pattern for electrically connecting any two first patterns adjacent to each other.

13. The touch device of claim 10, wherein the UV cut layer comprises a single-layered film structure or a multi-layered film structure.

14. The touch device of claim 10, wherein the material of the UV cut layer comprises a mixture of SiO₂ and SiN.

15. The touch device of claim 10, wherein the UV cut layer cuts off a UV light having a wavelength of less than 400nm.

16. The touch device of claim 10, wherein the UV cut layer cuts off a UV light having a wavelength of less than 300nm.

17. The touch device of claim 10, further comprising another UV cut layer disposed on another side of the cover lens opposite the side of the cover lens with the UV cut layer thereon.

18. The touch device of claim 10, wherein a space pattern between the transparent conductive patterns consists of a plurality of partially overlapping points.

19. The touch device of claim 18, wherein the shape of the partially overlapping points comprises a circle, a square, a rectangle, an ellipse or a rectangle with four round corners.

20. The touch device of claim 10, wherein the UV cut layer has a refractive index between a refractive index of the cover lens and a refractive index of the transparent conductive patterns.
